(19) United States
(12) Patent Application Publication
(10) Pub. No.: US 2007/0132334 A1
(43) Pub. Date: Jun. 14, 2007

(54) Systems and methods for providing electrical contact with a rotating element of a machine

(75) Inventor: Jack Kerlin, Springdale, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: RT Patent Company, Inc.

(21) Appl. No.: 11/302,889

(22) Filed: Dec. 14, 2005

(51) Int. Cl. H01R 39/00; H02K 13/00

(52) U.S. Cl. 310/231; 439/13

(57) ABSTRACT

In accordance with the teachings herein, systems and methods are described for providing electrical contact with a rotating element of a machine. In one example system, a nozzle may be used to emit a stream of a molten metal material, the nozzle being configured to transmit electric current from a power source to the stream of molten metal material. The rotating element may be supported within the machine to rotate relative to the nozzle, and may include a current collector ring. The nozzle may be operable to emit the stream of molten metal material onto a localized portion of the current collector ring to transfer the electric current from the power source to the current collector ring, the localized portion of the current collector ring being a portion of the current collector ring that is less than an entire circumference of the current collector ring.

### FIELD

The technology described in this patent document relates generally to electric motors and generators. More particularly, systems and methods are described for providing electrical contact with a rotating element of a machine.

### BACKGROUND

The earliest electrostatic motors and generators dating back to the early 19^{th} century relied upon filamentary metal brushes to transfer electric charge from the stationary power source to rotating members of the machine. Multiple fine hair-like whiskers constituted the so-called “brushes.” Each individual metallic fiber was individually suspended independent of the surrounding fibers. Accordingly, numerous contact points were afforded by the collection of discrete conductors acting in concert to conduct electric current between surfaces in relative motion with respect to one another.

Although the label “brushes” has remained in the lexicon of electrical engineering, the physical form of the brush changed radically with the advent of magnetically-based rotating machinery requiring electric currents thousands of times higher than those found in electrostatic machines. Solid blocks of graphite replaced the filamentary representation of the brush. Although a poor conductor compared to most metals, graphite nevertheless offered several unique features favoring serviceability above all other methods of current transfer between sliding surfaces: 1) graphite has natural lubrication properties; 2) graphite forms a protective film on the ring surface in the presence of atmospheric humidity and oxygen which shifts wear from the ring to the easily-replaceable brush; and 3) graphite has a peculiar thermal characteristic which causes it to vaporizes at very high temperature rather than melt (sublimation), which extends the operational life of the brush.

Electrical wear in conventional solid brushes accounts for about half of the total wear, the other half arising from dry mechanical friction. Electrical wear results from vaporization of graphite at several scattered contact points which randomly move across the interface surface. Extremely high current density creates local temperatures exceeding 5000° F., above the vaporization temperature of graphite.

The complex phenomena occurring at the interface of the slip-ring and graphite brush has been exhaustively studied for over a century. Based on decades of empirical practice, the combined effects of materials selection, brush pressure, surface speed, current density, atmospheric oxygen and humidity has been reduced to predictable and reproducible performance under specified conditions. In short, the operational characteristics of the graphite brush have been investigated seemingly to the theoretical limit. Nevertheless, demands of modern high current machine processes exceed the capability of the most advanced technologies of current collection based on conventional graphite brush technology.

Within the past decade there has been a revival of the basic filamentary brush concept. Known as “metal fiber brushes,” this modification of the original free-fiber brush incorporates numerous metal fibers bound together into a solid block somewhat resembling a standard graphite brush. Fibers are fused or bonded to one another within a proprietary matrix material. This device excels in many respects compared to graphite brushes, but remains inadequate to the demands of many industrial applications.

### SUMMARY

In accordance with the teachings herein, systems and methods are described for providing electrical contact with a rotating element of a machine. In one example system, a nozzle may be used to emit a stream of a molten metal material, the nozzle being configured to transmit electric current from a power source to the stream of molten metal material. The rotating element may be supported within the machine to rotate relative to the nozzle, and may include a current collector ring. The nozzle may be operable to emit the stream of molten metal material onto a localized portion of the current collector ring to transfer the electric current from the power source to the current collector ring, the localized portion of the current collector ring being a portion of the current collector ring that is less than an entire circumference of the current collector ring.

One example method for providing electrical contact with a rotating element of a machine may include the following steps: charging a molten metal material with an electric potential; and emitting a stream of the electrically charged molten metal material from a stationary element of the machine onto a localized portion of a current collector ring attached to the rotating element of the machine; the stream of electrically charged molten metal material supporting a transfer of electrical current from the stationary element of the machine to the rotating element of the machine.

### BRIEF DESCRIPTION OF THE DRAWINGS

FIG. 1 depicts an example system for providing electrical contact with a rotating element of a machine.

FIG. 2 depicts another example system for providing electrical contact with a rotating element of a machine.

FIG. 3 depicts another example system for providing electrical contact with a rotating element of a machine.

FIG. 4 depicts an example cross-sectional view that illustrates a stream of molten metal emerging from a nozzle onto the current collector ring of a rotating machine element.

FIG. 5 depicts another example system for providing electrical contact with a rotating element of a machine.

FIG. 6 depicts a cross-sectional view of another example system for providing electrical contact with a rotating element of a machine.

### DETAILED DESCRIPTION

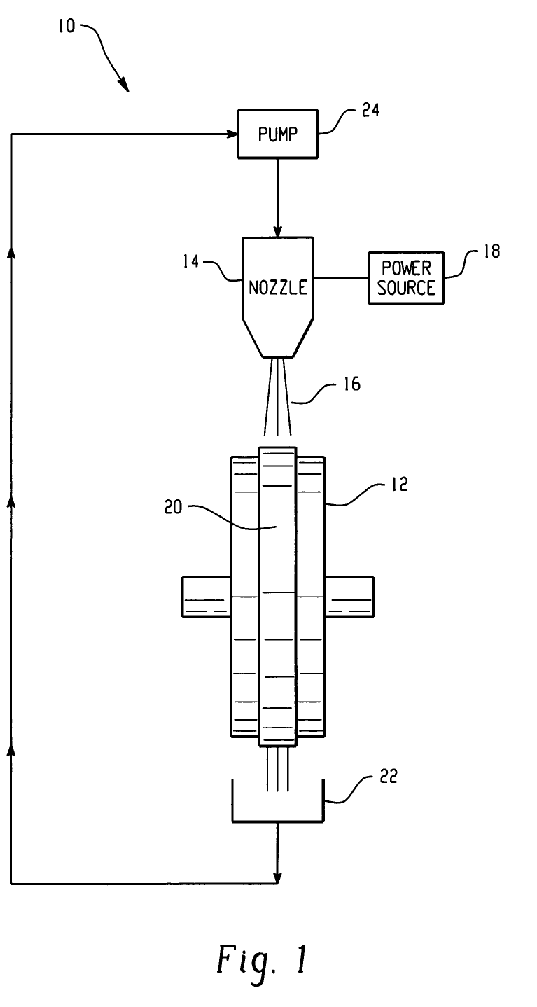

FIG. 1 depicts an example system 10 for providing electrical contact with a rotating element 12 of a machine. The example system 10 includes the rotating machine element 12 and a nozzle 14 that is positioned a short distance from the rotating machine element 12 and that is configured to emit a stream of a molten metal material 16. The nozzle is electrically coupled to a power source 18 and is configured to transmit electric current from the power source 18 to the stream of molten metal material 16. The rotating element is supported within the machine to rotate relative to the nozzle and includes a current collector ring 20. The rotating element 12 may, for example, be a rotor in an electric motor or generator. It should be understood that the power source 18 may supply power directly to the nozzle 14 or may supply power through one or more other circuit elements.

In operation, the nozzle 14 emits the stream of molten metal material 16 onto a localized portion of the current collector ring 20 to transfer electric current from the power source 18 to the current collector ring 20. As referred to herein, a localized portion of the current collector ring 20 is a portion of the current collector ring 20 that is less than an entire circumference of the current collector ring 20. Also illustrated in FIG. 1 is a reservoir 22 for collecting the molten metal material 16 that is emitted from the nozzle 14 and a pump 24 for transferring the molten metal material from the reservoir 22 to the nozzle 14.

Preferably, the molten metal material 16 is a metal having a low melting temperature relative to the surrounding structure of the pump 24, nozzle 14 and current collector ring 20. Example metals that may be used include eutectic alloys, such as alloys of bismuth, cadmium and lead, which have melting points in the range of about 107° to 180° F. These example low melting point metals may be readily accommodated within the example system of FIG. 1 without introducing exotic materials. It should be understood, however, that other materials may also be used to form the molten metal material 16.

As described above, the molten metal material 16 acts as a conductive intermediary between the nozzle 14 and the current collector ring 20. Electrical and thermal conductivity between these components is facilitated by wetting at the liquid-solid interface on the current collector ring 20. In many cases, however, the wetting phenomenon may be accompanied by dissolution of the solid ring material by a liquid eutectic metal. Thus, the current collector ring 20 may preferably be made of a material that is wetted, but not dissolved, by a eutectic liquid, such as an iron-nickel alloy, steel or stainless steel. It should be understood, however, that other materials could also be used for the current collector ring 20.

The system 10 depicted in FIG. 1 may reduce or eliminate the electrical and mechanical wear that occurs in a conventional system that uses brushes for current transfer. Electrical wear in conventional systems is partially the result of brush bounce that creates arcing. Analogous “brush bounce” in the system 10 of FIG. 1 should not occur as long as the radial velocity of the current collector ring surface 20 resulting from ring eccentricity and/or out-of-roundness is less than the stream velocity of the liquid metal stream 16 emitted by the nozzle 14.

Electric wear in conventional systems may also be partially due to the formation of localized hot spots around a small number of restrictive contact points at the brush-ring interface. These concentrated areas of conductivity create pin-point areas of high current density, ultimately leading to electric arcs that comprise the primary current-carrying mechanism between brush and ring during normal operation. The extremely high temperature of the electrical arcs ablates the graphitic brush material by evaporation. In the system 10 depicted in FIG. 1, however, the fluidic compliance of liquid metal at the impact point on the current collector ring 20 provides uniform electrical contact across the stream-ring interface cross-sectional area. This helps to prevent localized heating and formation of arcing, and thus significantly reduces electrical wear compared to conventional systems.

Mechanical wear in conventional systems may arise from the friction of solid surfaces sliding relative to one another. In the system 10 of FIG. 1, however, the liquid metal stream 16 traversing the aperture between moving members enables electrical connection in the absence of solid mechanical sliding contact, significantly reducing mechanical wear compared to conventional systems.

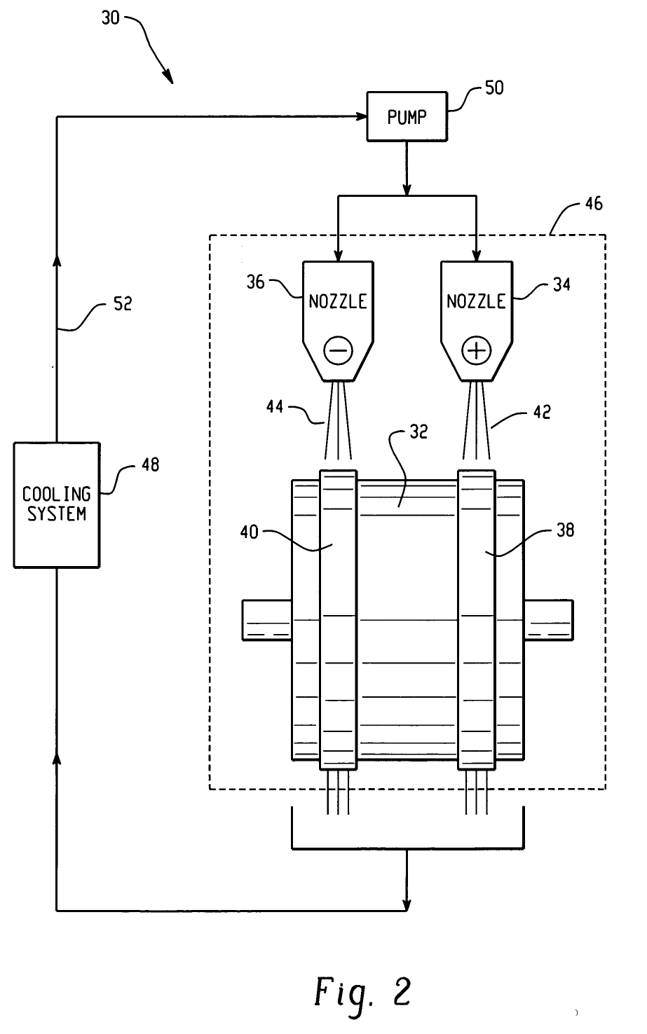

FIG. 2 depicts another example system 30 for providing electrical contact with a rotating element 32 of a machine. This example 30 include two nozzles 34, 36 and two corresponding current collector rings 38, 40 on the rotating element 32. In operation, the first nozzle 34 emits a first stream of molten material 42 onto a localized portion of the first current collector ring 38 to transfer electric current from a power source to the first current collector ring 38, and the second nozzle 36 emits a second stream of molten material 44 onto a localized portion of the second current collector ring 40 to transfer electric current from the power source to the second current collector ring 40. In addition, one nozzle 34 may be electrically coupled to a first voltage potential from of the power source, and the other nozzle 36 may be electrically coupled to a second voltage potential from the power source power source. For instance, in one example the first nozzle 34 may be electrically coupled to a positive terminal of the power source and the other nozzle 36 may be electrically coupled to a negative terminal of the power source.

FIG. 2 also depicts an enclosure 46 surrounding the nozzles 34, 36 and the current collector rings 38, 40, and a cooling system 48 between the rotating element 32 and the pump 50. The enclosure 46 may provide an inert atmosphere that helps to prevent oxidation of the metal materials. Most common metals, solid or liquid, experience surface oxidation upon exposure to air. The fine mist created by the impact of the steams of molten metal 42, 44 on the current collector rings 38, 40 moving at a high velocity may create a large surface area of molten metal. The ensuing high rate of oxidation may quickly convert most of the molten metal into an oxide powder if this process occurs in a gaseous atmosphere containing oxygen. Therefore, the enclosure 46 may be included to reduce the amount of oxygen in the atmosphere to acceptable levels. To further prevent oxidation, the inert atmosphere in the enclosure 46 may contain a small percentage of hydrogen (e.g., 4-5%) to create a reducing atmosphere. Hydrogen reverses any oxidation that may have occurred prior to purging the system of air, and helps to assure against further oxidation arising from residual oxygen remaining after the enclosure 46 is sealed.

The cooling system 48 may be used, in some examples, to remove excess heat from the molten metal material 42, 44. Typical bismuth eutectic alloys, which may be used for the molten metal material 42, 44, have an electrical conductivity around 5% that of pure copper. Electric current flowing through an eutectic metal therefore generates about 20 times more heat than copper under similar circumstances. Stream resistance is provided by the portion of the liquid metal stream between the nozzle tip and the current collector ring. The relatively short stream length that participates in current conduction represents a low value of absolute electrical resistance. However, heat generation may nevertheless be significant at very high current densities. Accordingly, the stream flow rate should be high enough to move heat away from the conduction zone and prevent undue increases in the localized temperature of the liquid metal.

The flowing liquid metal stream provides its own inherent cooling mechanism inasmuch as the heated liquid metal is continuously replaced by cooler material flowing into the heat generation region between the nozzle and the current collector ring. The cooling system 48 may be included to remove heat from the molten metal before it is returned to the nozzles 34, 36 by the pump 50. In some examples, an active cooling system could be used, such as cooling coils. In other examples, however, the return path 52 between the rotating element 32 and the pump 50 may act as the cooling system by providing sufficient time and conditions for the molten metal cool to a desired temperature range.

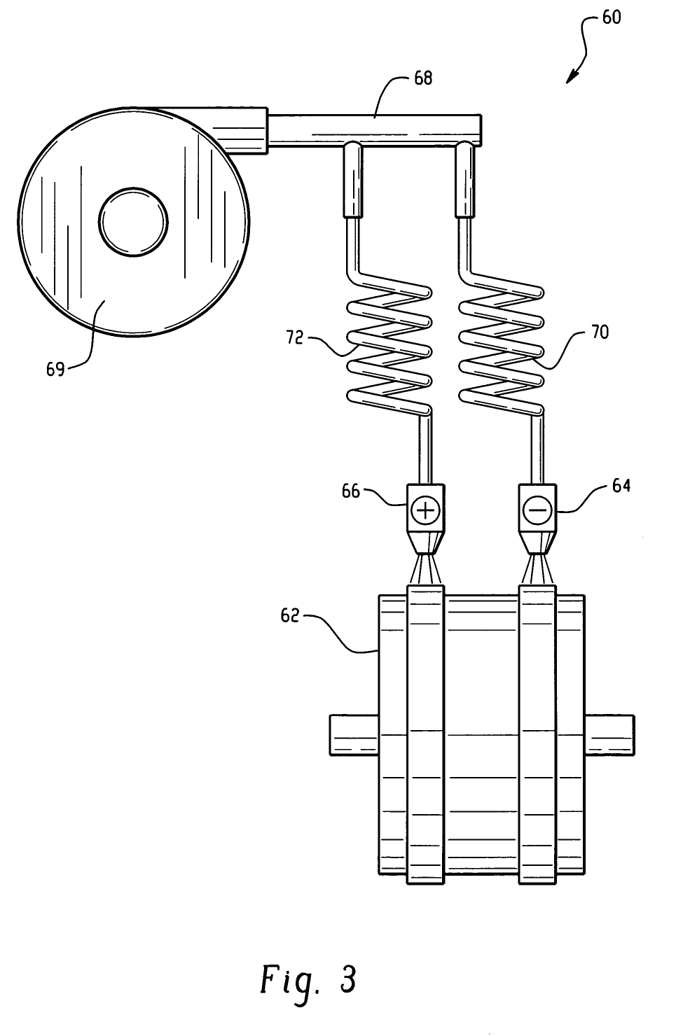

FIG. 3 depicts another example system 60 for providing electrical contact with a rotating element 62 of a machine. In this example, plural nozzles 64, 66 are connected to a common manifold 68 through liquid metal resistors 70, 72. The liquid metal resistors 70, 72 electrically isolate the nozzles 64, 66 from one another by imposing resistance into the molten metal electrical circuit. The resistance supplied by the liquid metal resistors 70, 72 supports any voltage difference that may exist between the nozzles 64, 66. The resistance may be created by constricting the molten metal flowing to each nozzle 64, 66 from the pump 69 within confined elongated passages that define the electrical pathway connecting the nozzles 64, 66 to the common manifold 68. The elongated passages of the liquid metal resistors 64, 66 may, for example, be created with narrow-bore non-conductive tubing. In the illustrated example, the liquid metal resistors 70, 72 are coiled helically, however other configurations that provide an elongated passage for the molten metal may also be used. For instance, in another example the liquid metal resistors 70, 72 may be formed from straight tubing that has a smaller inner diameter than the manifold 68.

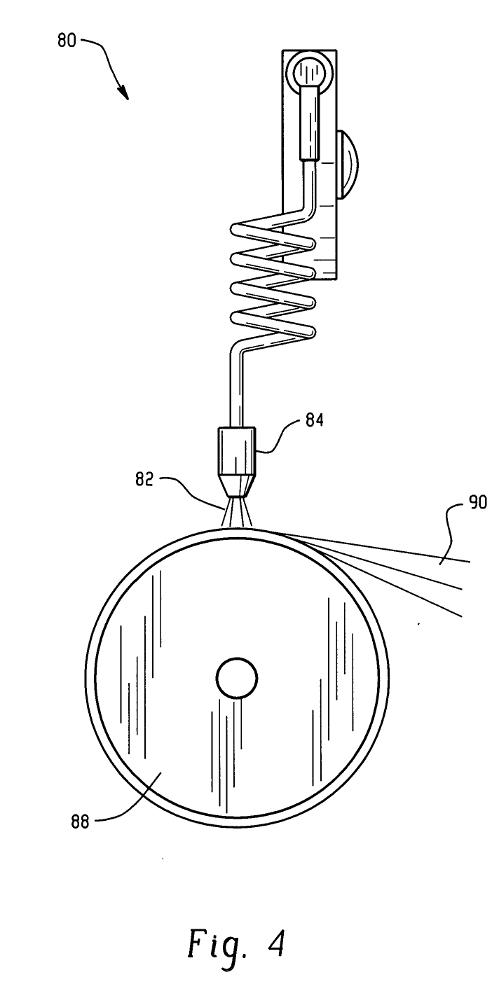

FIG. 4 depicts an example cross-sectional view 80 that illustrates a stream of molten metal 82 emerging from a nozzle 84 onto the current collector ring 86 of a rotating machine element 88. The stream 82 emerging from the nozzle 84 should have sufficient velocity to break into fine droplets upon impact with a stationary current collector ring 86 to prevent short-circuiting with adjacent nozzles at machine startup. At significant rotational speeds, the high velocity ring surface 86 propels liquid metal at the boundary layer into a tangential spray pattern 90 incapable of supporting electrical conduction. Stream flow rate also determines the rate at which heat is removed from the nozzle-ring conduction zone, as described above.

In addition, the cross-sectional area (thickness) of the liquid metal stream 82 emerging from the nozzle 84 should be sufficient to minimize electrical resistance and the attendant heat generation. The preferred thickness of the liquid metal stream 82 may be dependent on the voltage-current characteristics of the system 80. For example, in a system utilizing high current and low voltage, a thicker liquid metal stream 82 may be preferable. Conversely, in a system utilizing high voltage and low current, a thinner liquid metal stream 82 may be preferred.

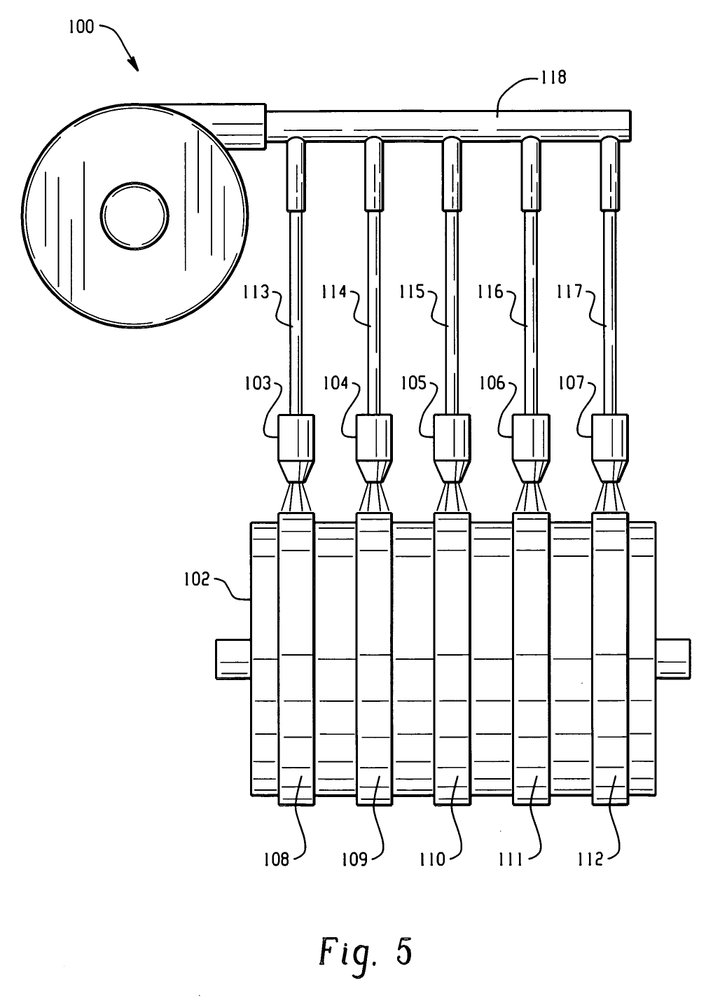

FIG. 5 depicts another example system 100 for providing electrical contact with a rotating element 102 of a machine. In this example 100, more than two nozzles 103-107 are provided for emitting streams of molten metal material onto respective current collector rings 108-112 of the rotating element 102. In one example, each of the plurality of nozzles 103-107 may be at a different electrical potential. This example 100 also depicts liquid metal resistors 113-117 that are formed from tubing having a smaller inner diameter than a common manifold 118 that supplies liquid metal to the nozzles 103-107.

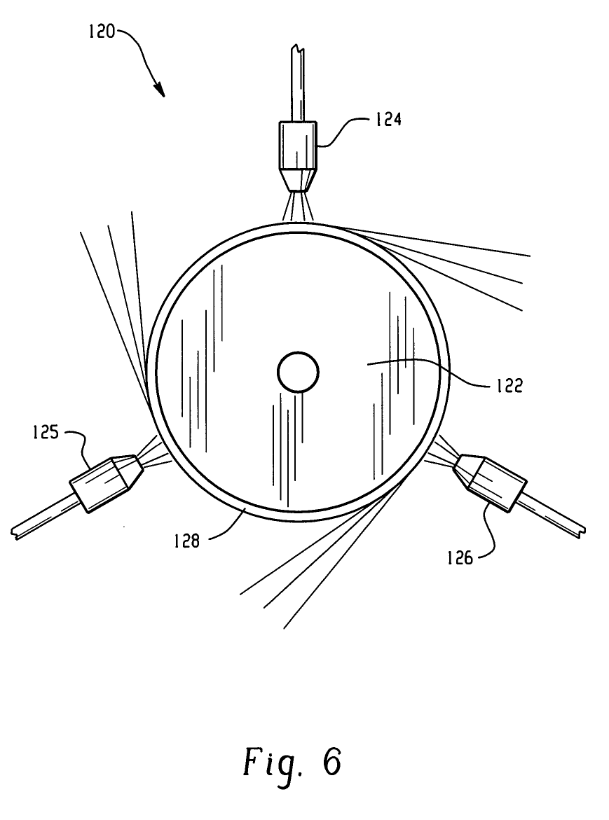

FIG. 6 depicts a cross-sectional view of another example system 120 for providing electrical contact with a rotating element 122 of a machine. In this example, the system 120 includes a plurality of nozzles 124-126 that emit streams of molten metal material onto different localized portions of the same current collector ring 128. Each of the plurality of nozzles 124-126 may, for example, be at a different electrical potential.

This written description uses examples to disclose the invention, including the best mode, and also to enable a person skilled in the art to make and use the invention. The patentable scope of the invention may include other examples that occur to those skilled in the art.

It is claimed:

1. A system for providing electrical contact with a rotating element of a machine, comprising:
a nozzle configured to emit a stream of a molten metal material, the nozzle being configured to transmit electric current from a power source to the stream of molten metal material; and
the rotating element supported within the machine to rotate relative to the nozzle, the rotating element including a current collector ring;
the nozzle being operable to emit the stream of molten metal material onto a localized portion of the current collector ring to transfer the electric current from the power source to the current collector ring, the localized portion of the current collector ring being a portion of the current collector ring that is less than an entire circumference of the current collector ring.

2. The system of claim 1, wherein the machine is an electric motor.

3. The system of claim 1, further comprising:
a pump coupled to the nozzle and configured to transfer the molten metal material to the nozzle.

4. The system of claim 3, further comprising:
a reservoir for collecting the molten metal material that is emitted from the nozzle;
wherein the pump transfers the molten metal material from the reservoir to the nozzle.

5. The system of claim 3, further comprising:
a second nozzle coupled to the pump and configured to emit a second stream of molten material, the second nozzle being configured to transmit electric current between the power source and the stream of molten metal material;
the rotating element including a second current collector ring; and
the second nozzle being operable to emit the second stream of molten material onto a localized portion of the second current collector ring to transfer electric current between the power source and the second current collector ring, the localized portion of the second current collector ring being a portion of the second current collector ring that is less than an entire circumference of the second current collector ring.

6. The system of claim 5, wherein the nozzle is charged to a first voltage potential by the power source and the second nozzle is charged to a second voltage potential by the power source.

7. The system of claim 6, wherein the nozzle is electrically coupled to a positive terminal of the power source and the second nozzle is coupled to a negative terminal of the power source.

8. The system of claim 5, further comprising:
a liquid metal resistor coupled between the nozzle and the pump, the liquid metal resistor providing an electrical resistance between the nozzle and the second nozzle.

9. The system of claim 8, further comprising:
a second liquid metal resistor coupled between the second nozzle and the pump, the second liquid metal resistor providing an additional electrical resistance between the nozzle and the second nozzle.

10. The system of claim 9, further comprising:
a manifold coupled between the pump and the liquid metal resistor and second liquid metal resistor.

11. The system of claim 9, wherein the liquid metal resistor and the second liquid metal resistor are formed from coiled tubing.

12. The system of claim 10, wherein the liquid metal resistor and the second liquid metal resistor are formed from tubing having a smaller inner diameter than the manifold.

13. The system of claim 4, further comprising a cooling system coupled between the reservoir and the pump, the cooling system being configured to remove heat from the liquid metal material.

14. The system of claim 1, further comprising:
a plurality of additional nozzles configured to emit additional streams of the molten metal material, the plurality of additional nozzles being configured to transmit electric current from the power source to the additional streams of molten metal material;
the rotating element including a plurality of additional current collector rings, with each one of the additional current collector rings corresponding to one of the plurality of additional nozzles;
the plurality of additional nozzles being operable to emit the additional streams of molten metal material onto localized portions of the additional current collector rings to transfer electric current between the power source and the additional current collector rings.

15. The system of claim 14, wherein the nozzle and the plurality of additional nozzles are each charged to a different voltage potential by the power source.

16. The system of claim 1, further comprising:
one or more of additional nozzles configured to emit one or more additional streams of the molten metal material, the one or more additional nozzles being configured to transmit electric current from the power source to the one or more additional streams of molten metal material;
the nozzle and the one or more additional nozzles being operable to emit the stream of molten metal material and the one or more additional streams of molten metal material onto different localized portions of the current collector ring to transfer electric current between the power source and the collector ring.

17. A method for providing electrical contact with a rotating element of a machine, comprising:
charging a molten metal material with an electric potential; and
emitting a stream of the electrically charged molten metal material from a stationary element of the machine onto a localized portion of a current collector ring attached to the rotating element of the machine;
the stream of electrically charged molten metal material supporting a transfer of electrical current from the stationary element of the machine to the rotating element of the machine.

18. A machine having a rotating element and a stationary element, comprising:
means for charging a molten metal material with an electric potential; and
means for emitting a stream of the electrically charged molten metal material from the stationary element of the machine onto a localized portion of a current collector ring attached to the rotating element of the machine;
the stream of electrically charged molten metal material supporting a transfer of electrical current from the stationary element of the machine to the rotating element of the machine.
